(19) United States
(12) Patent Application Publication
(10) Pub. No.: US 2024/0270033 A1
(43) Pub. Date: Aug. 15, 2024

(54) KIT FOR REMOVING AND/OR INSTALLING A VEHICLE TIRE FROM/ON A WHEEL RIM

(71) Applicant: Crank Brothers, Inc., Laguna Beach, CA (US)

(72) Inventors: Frank HERMANSEN, Laguna Beach, CA (US); Carl WINEFORDNER, Laguna Beach, CA (US)

(21) Appl. No.: 18/108,378

(22) Filed: Feb. 10, 2023

(51) Int. Cl. B60C 25/02

(52) U.S. Cl. CPC B60C 25/02

(57) ABSTRACT

The present invention relates to a kit for removing and/or installing a vehicle tire from/on a wheel rim including at least one tire lever and at least one slider component, the at least one slider component delimiting a seat suitable for fitting over a sidewall or edge of a wheel rim and includes a base portion as well as a leg portion extending from the base portion and delimiting therewith the seat, the leg portion being suitable for securing a tire bead in a fixed position over a wheel rim sidewall or edge.

### TECHNICAL FIELD OF THE INVENTION

The present invention relates generally to the field of vehicle, such as bicycle or motorcycle accessories and more particularly to the field of bicycle tire lever system for removing and installing bicycle tires or the tubes thereof.

### STATE OF THE ART

Bicycle tire levers are typically made in the same way, namely a two or three pack of about 4.5 inch long by 0.6 inch by 0.3 inch each plastic pieces with a removal hook at one end for prying under the bead of the tire and a notch at the other end for catching under a spoke.

Something that has changed in recent years is that bicycle tires are now often designed to hold air without the need for an inner tube. In order to achieve this, these “tubeless” tires are thicker, stiffer, and fit tighter to the bicycle wheel rim. This makes it increasingly difficult to install bicycle tires. The tightness can require extensive strength to install, and can cause plastic tire levers to become damaged or broken.

In some cases, installing a bicycle tire requires two strong people to work together. Additionally, users often add around 2 to 4 ounces of liquid tire sealant to the tire during installation, which can cause a messy spill on the floor if the tire bead inadvertently comes off the rim during installation.

Even tires that require inner tubes to be used can sometimes be so tight that it is extremely difficult to install the tire.

### SUMMARY OF THE INVENTION

It is therefore a principal object of the present invention to provide a radically innovative tire lever system which may be used conventionally to remove tires and innovatively to more easily install tires on wheels, regardless of the tire to rim tightness, wheel size or hub configuration.

It is another object of the invention to provide a vehicle, such as bicycle or motorcycle tire lever system that can, with low force, install tires on especially tight tire/rim combinations.

It is still another object of the invention for the tire levers and sliders, which can be conveniently assembled together for ease of transportation and storage.

According to the present invention a kit for removing and/or installing a vehicle tire from/on a wheel rim is provided as described in the present application.

The present application refers to preferred and advantageous embodiments of the invention.

### BRIEF DESCRIPTION OF THE DRAWINGS

These and other advantages will be better understood by any person skilled in the art from the following description and from the attached drawings, given as a non-limiting example, in which:

FIGS. 1 and 2 are perspective exploded views of the present invention;

FIG. 3 is a perspective view of part of a bicycle wheel with one component of the present invention being used;

FIG. 4 is a cross sectional view of the bicycle wheel shown FIG. 3;

FIGS. 5 to 10 are a perspective view, a side view, a top view, end vies, a bottom view, respectively of the present invention;

FIGS. 11 and 12 are cross sectional views of the invention shown in FIG. 7; and

FIGS. 13 to 28 shows the steps of a method for installing a bicycle tire on a wheel rim in accordance with the present invention.

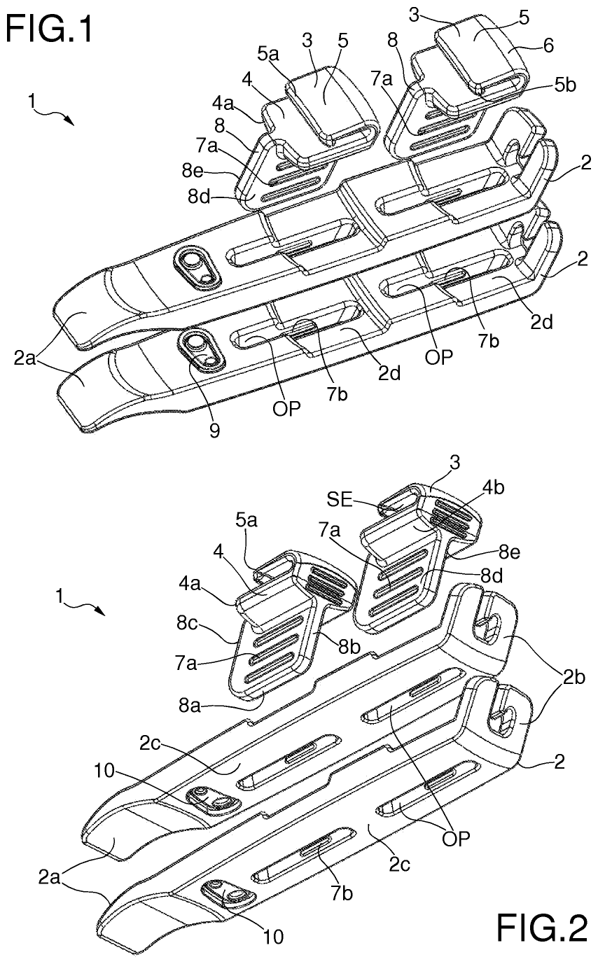

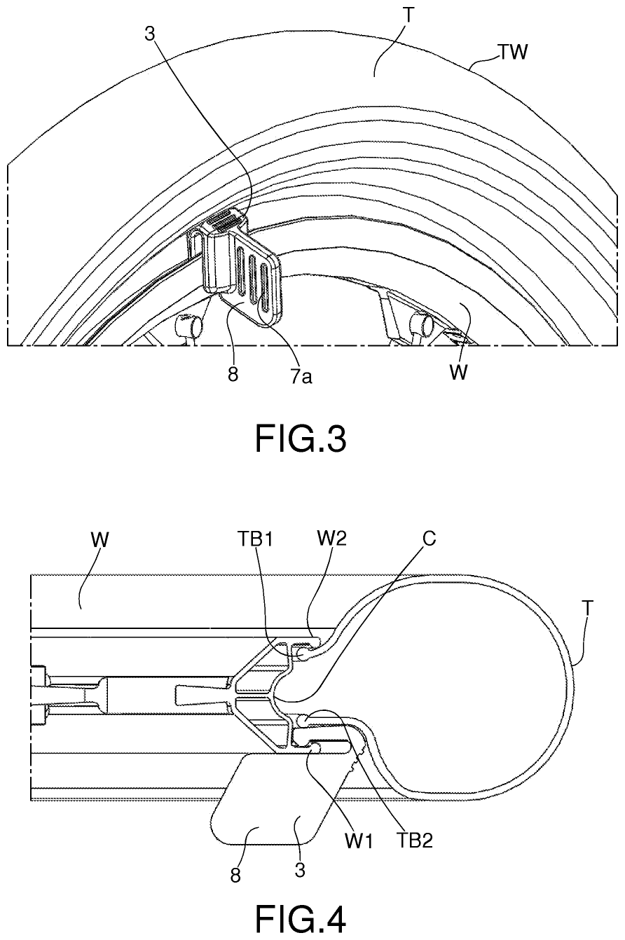

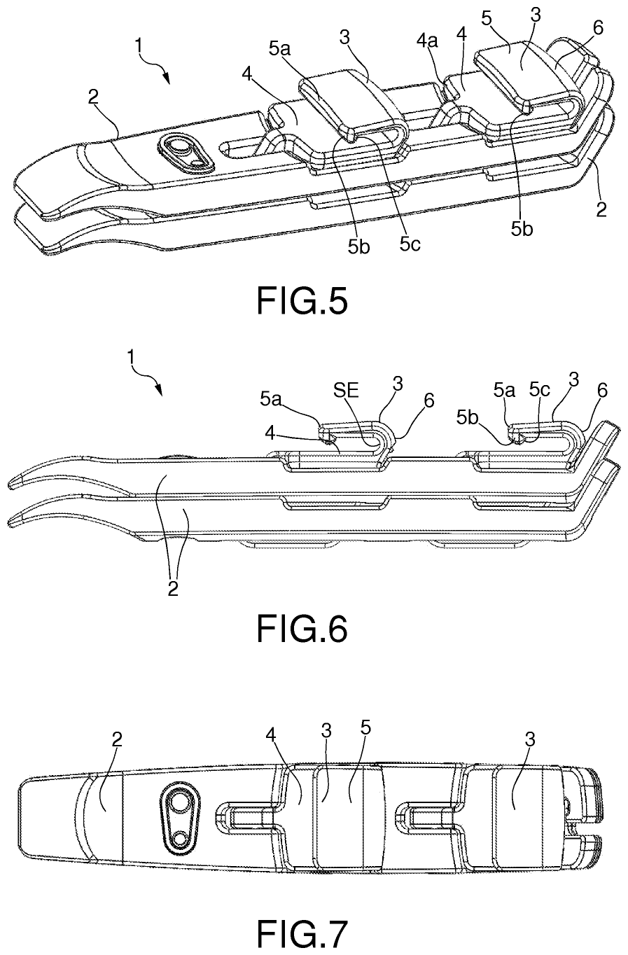

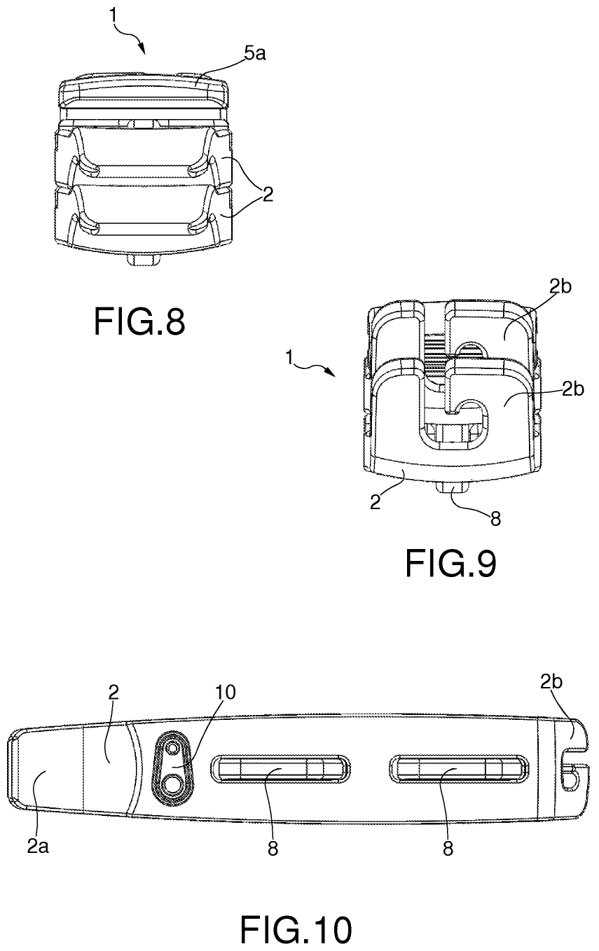

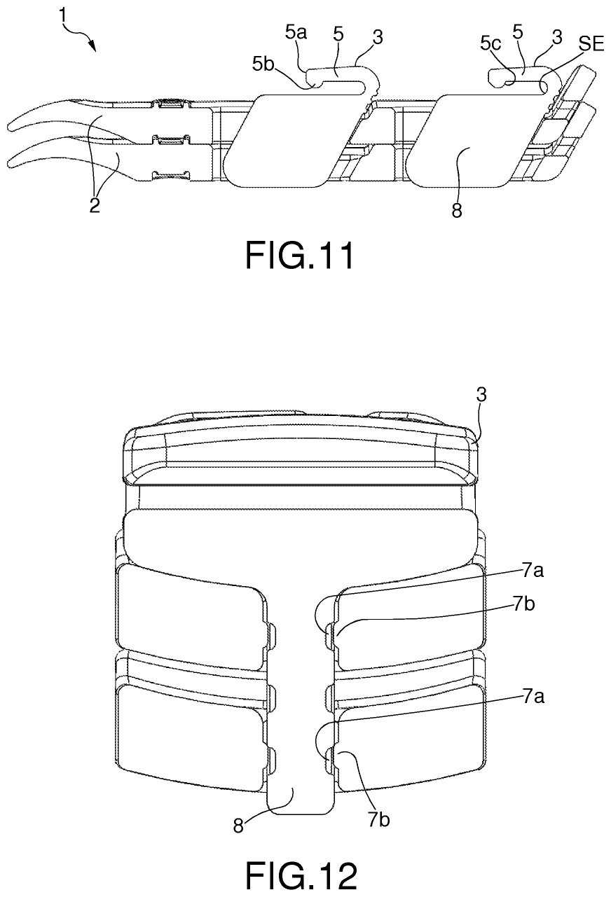

### DETAILED DESCRIPTION OF THE EMBODIMENTS OF THE INVENTION

The present invention relates to a kit 1 for removing and/or installing a vehicle tire, such as a bicycle or motorcycle tire T from/on a wheel rim W comprising at least one tire lever 2 and at least one slider component 3.

Advantageously, the kit 1 comprises at least two tire levers 2 with all or part of the components/features in common with one another.

Preferably, the kit 1 comprises at least two slider components 3 with all or part of the components/features in common with one another.

In the following we will refer to one slider component and to one tire lever, but the same reasoning could be applied to all or some the slider components and tire levers of the kit.

The slider component 3 delimits a seat SE suitable for fitting over a sidewall or edge of a vehicle wheel rim W and includes a base portion 4, preferably plate-shaped, as well as a leg portion 5, preferably plate-shaped, extending from one end of the base portion 4 and delimiting therewith the seat SE.

Of course, the slider component 3 can further include a portion of connection 6 of the leg portion 5 to the base portion 4, so that the components 4, 5, 6 substantially defines a U-shaped part of the slider component 3 and the leg portion 5 extends from the base portion 4 with interposition of the portion of connection 6. With reference to such an aspect, the main extension plane of the base portion 4 can be parallel to the main extension plane of the leg portion 5 or the same can be slightly inclined (e.g. from 0 to 10° degrees) with respect to one another.

In accordance with the not limiting embodiment shown in the figures, the leg portion 5 has an extension, i.e. distance of the respective free end 5a from the portion of connection 6, less than (among half and two-thirds of) the extension of the base portion 4, i.e. distance of the respective free end 4a from the portion of connection 6. Of course, the same elements 4, 5 could have the same extension or the leg portion 5 an extension greater than the base portion 4.

The leg portion 5 is suitable for securing a tire bead TB2 in a fixed position inside or over a wheel rim sidewall or edge W1.

In this respect, the free end 5a of the leg portion 5 could be L-shaped or could include a protruding part 5b defining an inner shoulder 5c facing the seat SE or the inner surface of the portion of connection 6.

The base portion 4 can have suitable size, for example:
length, i.e. the distance of the free end 4a from the connection portion 6, for example about 20 mm as shown but could range from 8 mm to 30 mm, and/or
width, i.e. the distance between the two flanks or side edges, for example about 20 mm as shown but could range from 8 mm to 40 mm, and/or
thickness, i.e. the distance among the surface outer the seat SE and the surface inner the seat SE, for example about 5 mm as shown but could range from about 1 mm to 7 mm.

The length of the base portion 4 is preferably constant for the whole extension thereof, i.e. for the whole extension of the free end 4a.

The width of the base portion 4 is preferably constant for the whole extension thereof, i.e. for the whole extension of its flanks or side edges.

The leg portion 5 can have suitable size, for example:
length, i.e. the distance of the free end 5a from the connection portion 6, for example about 15 mm as shown but could range from 7 mm to 20 mm, and/or
width, i.e. the distance between the two flanks or side edges, for example about 20 mm as shown but could range from 8 mm to 40 mm, and/or
thickness, i.e. the distance among the surface outer the seat SE and the surface inner the seat SE, for example 4 mm as shown but could range from 1 mm to 7 mm.

The length of the leg portion 5 is preferably constant for the whole extension thereof, i.e. for the whole extension of the free end 5a.

The width of the leg portion 5 is preferably constant for the whole extension thereof, i.e. for the whole extension of its flanks or side edges.

The slider component 3 is preferably enbloc or made in a single piece.

In this respect, the slider component 3 can be made of any suitable material, such as injection molded Nylon or Acetal plastics or metal such as aluminum or steel.

Preferably, the tire lever 2 and the slider component 3 have mutual connection means 7a, 7b for removable connection one with the other, for example to snap with one another, yet allowing easy disassembly for use.

Moreover, the slider component 3 can have a handle or flange portion 8 extending from the base portion 4 away from the leg portion 5, i.e. from a surface 4b of the base portion 4 distal from the leg portion 5 and outside the seat SE.

The handle portion 7 ensures a grasping portion of the slider component 3 suitable for making it possible for a user to push or control the sliding or displacement of the slider component 3 along a wheel rim sidewall or edge W1.

With reference to the not limitative embodiment shown in the figures the handle or flange portion 8 is plate-like shaped and has a plane of main extension which is substantially inclined or orthogonal to the plane of main extension of the base portion 4.

Moreover, the handle portion 8 could have threes free edges, i.e. one main edge 8a distal from the base portion 4 and two side edges 8b, 8c, which side edges lies in plane substantially parallel to one another and parallel or inclined with respect to the axis orthogonal to the plane of main extension of the base portion 4.

The handle portion 8 has two main surfaces 8d, 8e, parallel to one another and lying in the plane of main extension of the handle portion 8.

Advantageously, the tire lever 2 delimits at least one opening or slot OP, preferably a through opening, whereas the slider handle portion 8 is insertable therethrough for storage of the kit 1.

The opening or slot OP could have a direction of main extension substantially corresponding or parallel to the direction of main extension of the tire lever 2.

With reference to the not limiting embodiment shown in the figures, the tire lever 2 delimits two through openings or slots OP, which can be aligned to one another along the direction of main extension of the tire lever 2, so that the handle portions 8 of two slider components 3 can be each inserted in a respective through opening OP, thereby rendering it possible to connect contemporaneously two slider components 3 to at least one tire lever 2.

The handle portion 8 can have suitable size, for example:
length, i.e. the distance of the main edge 8a from the base portion 4, for example 116 mm as shown but could range from 70 mm to 300 mm, and/or
width, i.e. the distance between the two side edges 8b, 8c, for example 22 mm as shown but could range from 12 mm to 30 mm, and/or
thickness, i.e. the distance among the main surfaces 8d, 8e, for example ranging between 2 mm and 10 mm.

If the tire lever 2 and the slider component 3 have mutual connection means 7a, 7b, the latter can be for example provided at the slider handle portion 8 and at the tire lever opening or slot OP.

In this respect, the mutual connection means 7a, 7b can include at least one protrusion 7a extending from the slider handle portion 8 or rather from one or from both the main surfaces 8d, 8e thereof and at least one hollow zone 7b formed in the inner surface of the tire lever 2 delimiting the tire lever opening OP, the protrusion being engageable, for example by snap or to size, with the hollow zone/s.

In addition or as an alternative, the mutual connection means 7a, 7b can include at least one recessed zone 7a formed in the slider handle portion 8 (preferably at one or both the main surfaces 8d, 8e thereof) and at least one lug 7b extending from the inner surface of the tire lever 2 delimiting the tire lever opening OP, the lug being engageable, for example by snap or to size, with the recessed zone.

With reference to the not limitative embodiment shown in the figures, the mutual connection means 7a, 7b include at least two or three recessed zones and/or protrusions 7a formed in the slider handle portion 8 at one of the main surfaces 8d and at least two or three recessed zones and/or protrusions 7a formed in the slider handle portion 8 at the other main surfaces 8e.

In this case, the recessed zones and/or protrusions 7a are substantially parallel to one another and each at a respective distance from the base portion 4 greater or lower than the other/s.

With reference to the not limitative embodiment shown in the figures, the tire lever 2 includes at least two lugs or hollow zones 7b extending from the inner surface of the tire lever 2, one from a respective section of the surface extending in the main direction of the through opening OP, so that one lug or hollow zone 7b engages or rather is suitable for engaging one recessed zone and/or protrusion 7a on one main surface 8d of the slider handle portion 8, when another lug or hollow zone 7b engages one recessed zone and/or protrusion 7a on the other main surface 8e of the slider handle portion 8.

Of course, the amount of snap fit desired can be fine tuned by increasing the height of the recessed zone and/or protrusion 7a, on the one side, and of the lug or hollow zone 7b, on the other side.

The tire lever 2 is preferably enbloc or made in a single piece.

In this respect, the tire lever 2 can be made of any suitable material, such as injection molded Nylon or Acetal plastics or metal such as aluminum or steel.

So far as the tire lever 2 is concerned, it could have a first end 2a, which is curved or bent and is suitable for engaging a tire bead and a second end 2b.

The second end 2b could, for example define a hook portion suitable for hooking onto wheel spokes during tire removal.

The tire lever 2 could be plate shaped with an intermediate main section 2c extending along a main plane (length and width) separating the first curved or bent end 2a (at one side of the tire lever 2) and the second hook end 2b (at the other side of the tire lever 2).

With reference to the not limitative embodiment shown in the figures, the second hook end 2b is inclined with respect to the main plane of the main section 2c, for example between 30° and 90°.

The main section 2c could have a constant thickness for the whole extension or even one or more portions at reduced thickness 2d, for example at the zone defining the through opening/s OP. With reference to such an aspect, the portion at reduced thickness 2d ensures or provides a proper receiving zone for the slider component 3 or rather for the respective base portion 4 for storage of the kit 1 or of the slider component 3 with the tire lever 2.

With reference to the not limitative embodiment shown in the figures, the main section 2c delimits two portions at reduced thickness 2d, each for a respective slider component 3, for example one close to the second end 2b, and the other at an intermediate part of the main section 2c.

Additionally, if two tire levers 2 are provided, the same could have also one or more embossed portions 9 on one surface or side of the main section 2c and one or more notches 10 on the other surface or side of the main section 2c, so that the embossed portion/s 9 of one tire lever 2 can fit snuggly into the notch/es 10 of the other tire lever 2, in order to key the two tire levers 2 more securely together.

More particularly, if two tire levers 2 were arranged, with reference to the not limitative embodiment shown in the figures, the same are placed one over the other, with a surface (upper or lower) of the main section 2c in contact or abutment with the other surface of the main section (lower or upper), so that each through opening OP, is provided, of one tire lever 2 is substantially aligned with the through opening OP of the other tire lever 2.

Subsequently, the slider component/s 3 can be connected to the tire levers 2 through the mutual connection means 7a, 7b (if provided), for example inserting the handle or flange portion 8 into two aligned through openings OP.

Thus, advantageously, the kit in a stored trim or arrangement includes at least one tire lever 2 connected to at least one slider component 3, for example two tire levers 2 connected to one another and two slider components 3 both connected to both the tire levers 2.

Of course, when the kit 1 is to be used, the respective components 2, 3 should be first disassembled or disconnected.

Subject-matter of the present invention is also a method for installing a vehicle (for example bicycle or motorcycle) tire on a wheel rim with a kit 1 as above mentioned for obtaining a vehicle tired wheel TW.

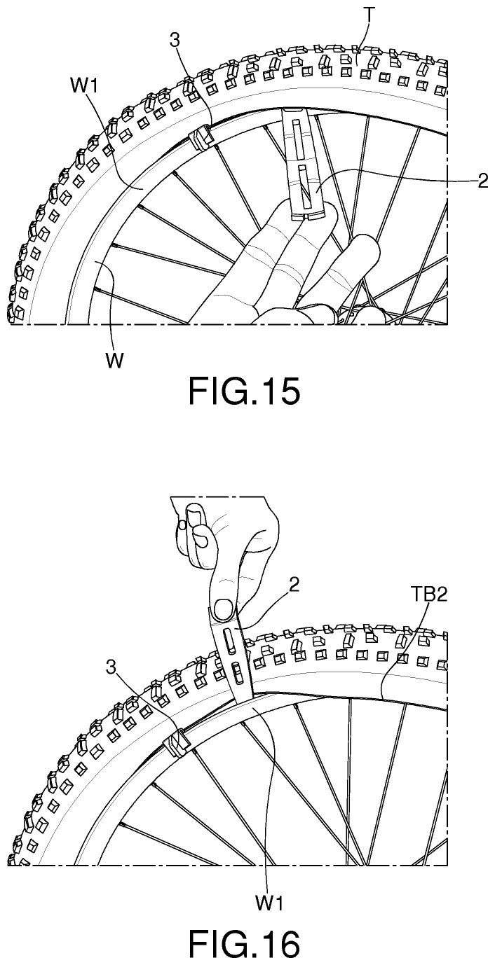

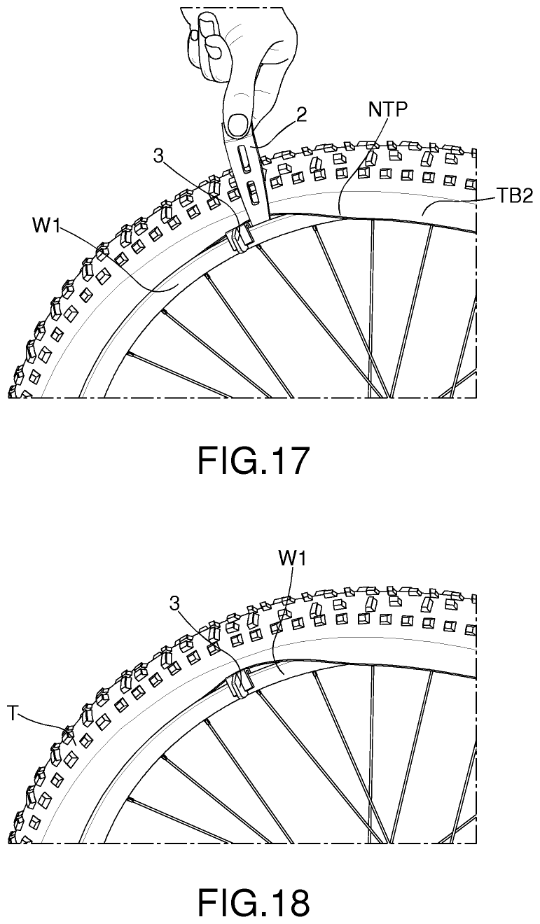

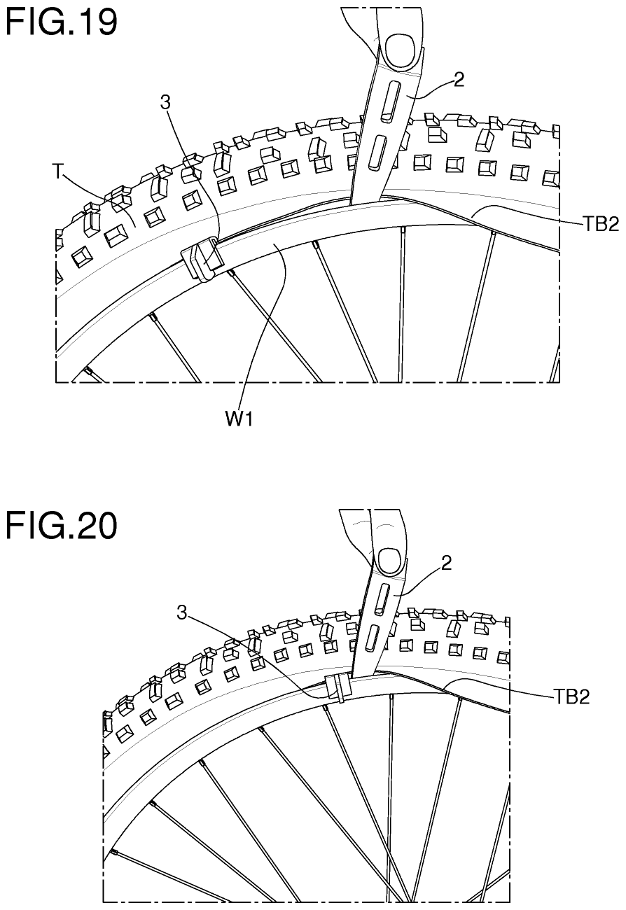

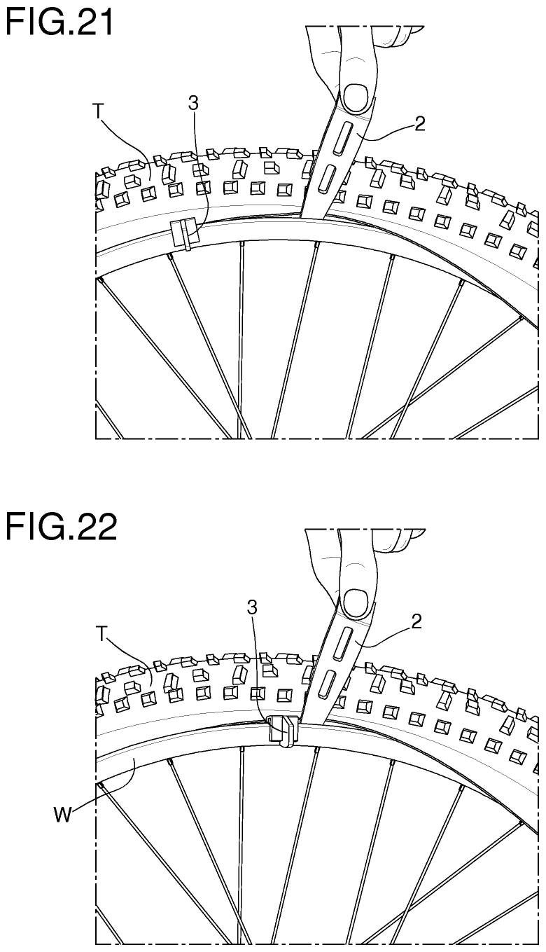

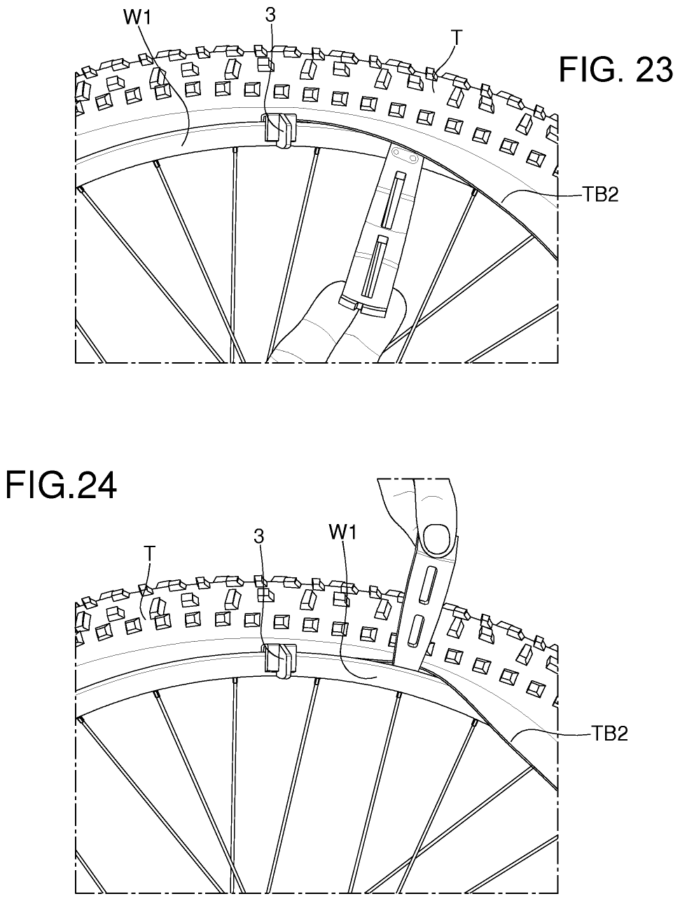

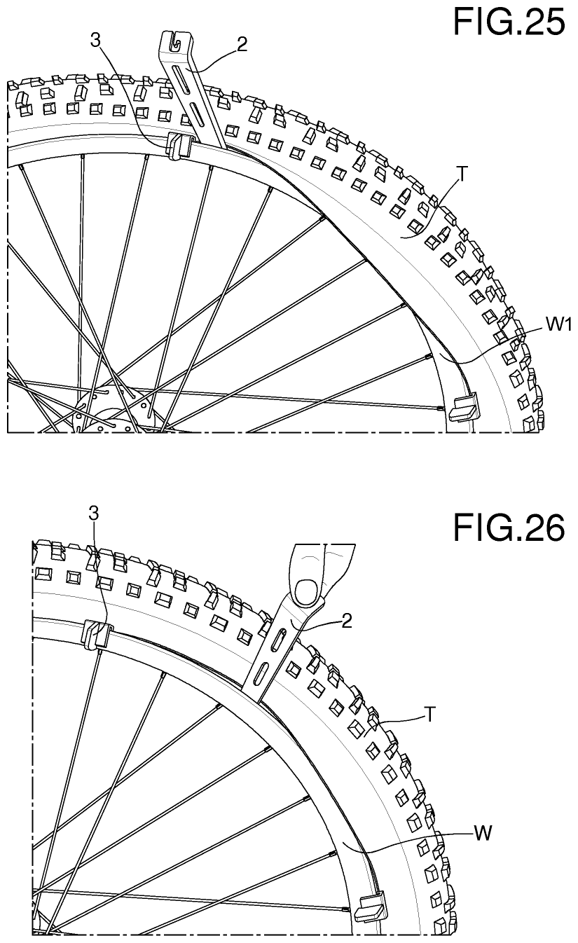

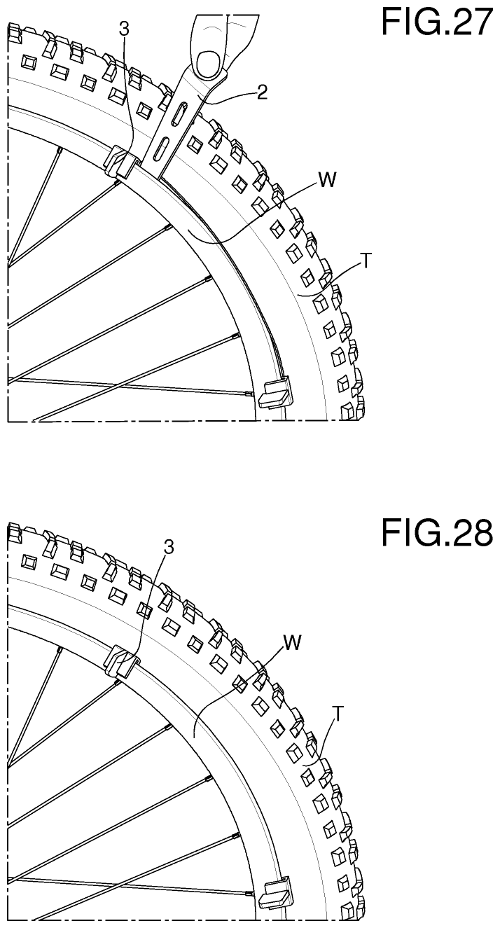

In this respect, such method comprises the following step:
arranging a kit 1;
inserting a first tire bead TB1 of a tire T in the annular or tubular channel C defined by the edges W1, W2 of a wheel rim W;
installing, for example manually, part of the second tire bead TB2 of the tire T in the channel C, so that the other part NTP (for example between 50% and 10%) of the second tire bead TB2 is outside the channel C and proximal to a first edge W1 and distal from the second edge W2 of the wheel rim W;
mounting at least one slider component 3 on the first edge W1 at a first end of the not installed part NTP of the second tire bead TB2 (FIG. 13), in order to prevent the second bead TB2 from propagating out of the wheel rim channel C, the slider seat SE fitting over the wheel rim edge W1, whereas the protruding part 5b, if provided, engages the wheel rim edge W1;
inserting (FIG. 15) a tire lever 2 (this step could also be accomplished after the mounting step of the slider component 3) at a distance from the slider component 3 between the wheel rim edge W1 and a respective part NTP of not installed second tire bead TB and displacing or moving, for example lifting up or down (FIG. 16) the tire lever 2 up to force a respective section of the not installed part NTP of the second bead TB2 over the wheel rim edge W1 and into the wheel rim channel C;
moving (FIG. 17) the slider component 3 along wheel rim edge W1 towards, optionally up to reach, the tire lever 2, thereby forcing the not installed part of the second tire bead among the slider component 3 and the tire lever 2 into the wheel rim channel C;
removing (FIG. 18) the tire lever 2;
reinserting the tire lever 2 between the wheel rim edge W1 and a respective part of the not installed second tire bead TB2 at a given distance from the slider component 3, displacing or moving, for example lifting up or down (FIG. 19) the tire lever 2 to push another section of the second bead TB2 over the wheel rim edge W1 and into wheel rim channel C and then moving the slider component 3 along the wheel rim edge W1 towards the tire lever 2, thereby forcing the not installed part among the slider component 3 and the tire lever 2 into the wheel rim channel C; and
repeating (FIGS. 20-27) the above-mentioned step until all the second tire bead TB2 has been inserted in the wheel rim channel C.

As it will be understood, the not installed part NTP varies (reduces) during the implementation of the method.

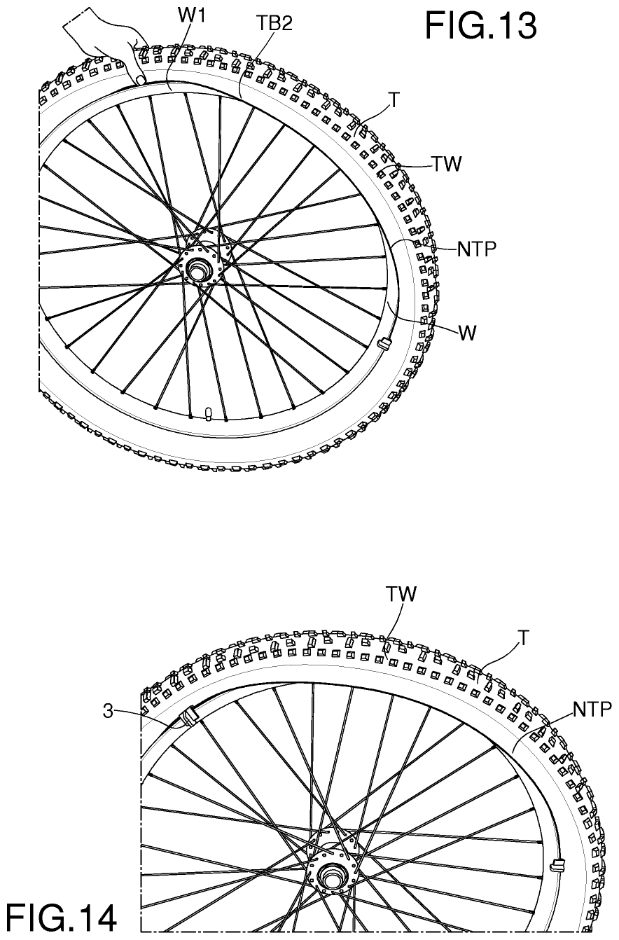

If the kit 1 includes two slider components 3, before or after the first mounting step of the first slider component 3 has been accomplished, and before the other steps of the method, a second slider component 3 is mounted (FIG. 14) onto wheel rim edge W1 at a distance from the first slider component 3 greater than the tire lever 2 and at a second end of the not installed part of the second tire bead TB2, preferably so that the sole part of the second tire bead TB2 that remains to be installed is between the two slider components 3.

Needless to say, the tire bead TB1, TB2 and the edges W1, W2 of the wheel rim are substantially tubular or annular.

Of course, the second slider component 3 can be maintained substantially fixed in position throughout the whole method for installing.

As it will be appreciated, the method for installing is an iterative, but easy, process, and at no point a large amount of strength is required.

As a matter of fact, the first slider component 3 functions as a “third hand” to keep the installed portion of tire bead TB2 fixed to the edge W1, and a similar function is accomplished by the second slider component 3.

For tire removal, one or both tire levers 2 are used as is typical in the prior art. Particularly tight tire/rim combinations will likely require both tire levers and less tight combinations may require only one tire lever.

It will now be understood that what has been disclosed herein comprises a preferred embodiment of a radically innovative kit for removing and/or installing a vehicle, such as bicycle or motorcycle tire from/on a wheel rim.

The kit is especially useful for removing and installing bicycle tires.

However, the invention is also readily configured for removing any tire mounted on a wheel such as motorcycle tires.

The present invention has been described according to a preferred embodiment, but equivalent variants can be devised without departing from the scope offered by the following claims.

1. A kit for removing and/or installing a vehicle tire from/on a wheel rim comprising at least one tire lever and at least one slider component, said at least one slider component delimiting a seat suitable for fitting over a sidewall or edge of a wheel rim and includes a base portion as well as a leg portion extending from the base portion and delimiting therewith said seat, said leg portion being suitable for securing a tire bead in a fixed position over a wheel rim sidewall or edge.

2. The kit as claimed in claim 1, wherein said at least one tire lever and said at least one slider component have mutual connection means for removable connection one with the other.

3. The kit as claimed in claim 1, wherein said slider component has a handle or flange portion extending from a surface of said base portion distal from said leg portion, said handle portion ensuring a grasping portion of said slider component suitable for making it possible for a user to push or control the sliding or displacement of the slider component along a wheel rim sidewall or edge.

4. The kit as claimed in claim 3, wherein said at least one tire lever delimits at least one opening or slot suitable for housing said flange portion of said slider component for storage of said kit.

5. The kit as claimed in claim 4, wherein said at least one tire lever and said at least one slider component have mutual connection means for removable connection one with the other and wherein said mutual connection means are provided at said flange portion and at said tire lever opening.

6. The kit as claimed in claim 5, wherein said mutual connection means include at least one protrusion or recessed zone extending from or formed in said handle portion and at least one hollow zone or lug, respectively, formed in or extending from the wall of said tire lever delimiting said tire lever opening.

7. The kit as claimed in claim 1, wherein said at least one tire lever has a first end, which is curved or bent and is suitable for engaging a tire bead and a second end.

8. The kit as claimed in claim 7, wherein said second end of said at least one tire lever defines a hook portion suitable for hooking onto wheel spokes during tire removal.

9. The kit as claimed in claim 1, wherein the free end of the leg portion is L-shaped or includes a protruding part defining an inner shoulder facing the seat or the inner surface of a portion of connection among the base portion and the leg portion.

10. The kit as claimed in claim 1, wherein the main section of the tire lever has a one or more portions at reduced thickness providing a receiving zone for the base portion of the slider component for storage of said kit.

11. The kit as claimed in claim 1, comprising at least two slider components.

12. The kit as claimed in claim 1, comprising at least two tire levers.

13. The kit as claimed in claim 12, wherein said at least two tire levers have one or more embossed portions on one surface or side of the respective main section and one or more notches on the other surface or side of the main section, so that one embossed portion of one tire lever can fit snuggly into a respective notch of the other tire lever, in order to key the two tire levers securely together.

14. A method for installing a tire on a wheel rim for obtaining a vehicle tired wheel comprising the following steps:
arranging a kit for removing and/or installing a vehicle tire from/on a wheel rim comprising at least one tire lever and at least one slider component, said at least one slider component delimiting a seat suitable for fitting over a sidewall or edge of a wheel rim and includes a base portion as well as a leg portion extending from the base portion and delimiting therewith said seat, said leg portion being suitable for securing a tire bead in a fixed position over a wheel rim sidewall or edge,
inserting a first tire bead of a tire in the channel defined by the edges of a wheel rim,
installing part of the second tire bead of the tire in said channel,
mounting at least one slider component on a first edge of the wheel rim at a first end of the not installed part of the second tire bead, in order to prevent the second bead from propagating out of the wheel rim channel, said seat fitting over the first edge of said wheel rim,
inserting said at least one tire lever at a distance from said at least one slider component between the first edge of said wheel rim and a respective part of not installed second tire bead and moving said at least one tire lever up to force a respective section of the second tire bead over the first edge and into wheel rim channel,
moving said at least one slider component along the first edge of said wheel rim towards said at least one tire lever, thereby forcing the not installed part of the second tire bead among the slider component and the tire lever into the wheel rim channel,
removing said at least one tire lever,
reinserting said at least one tire lever between the first edge of said wheel rim and a respective part of not installed second tire bead at a distance from said at least one slider component, moving said at least one tire lever to push another section of the second tire bead over the first edge of the wheel rim and into wheel rim channel,
moving said at least one slider component along the first edge of the wheel rim towards said at least one tire lever, thereby forcing the not installed part of the second tire bead among the slider component and the tire lever into the wheel rim channel, and
repeating the above-mentioned step until all the second tire bead has been inserted in the wheel rim channel.

15. The method as claimed in claim 14, wherein said kit includes at least two sliders, and wherein before or after the first mounting step of said at least one first slider component, and before the other steps of the method, a second slider component is mounted onto the first edge of the wheel rim at a distance from said at least one first slider component greater than said tire lever and at a second end of the not installed part of the second tire bead, so that the sole part of the second tire bead that remains to be installed is between the two slider components.
